(19) United States
(12) Patent Application Publication
(10) Pub. No.: US 2009/0065426 A1
(43) Pub. Date: Mar. 12, 2009

(54) SPIRAL MEMBRANE ELEMENT

(75) Inventors: Katsumi Ishii, Osaka (JP); Shinichi Chikura, Osaka (JP); Hideki Matsuda, Osaka (JP); Masashi Beppu, Osaka (JP); Hiroki Fujioka, Osaka (JP); Yasuhiro Uda, Osaka (JP)

Correspondence Address: KNOBBE MARTENS OLSON & BEAR LLP, 2040 MAIN STREET, FOURTEENTH FLOOR, IRVINE, CA, 92614, US

(73) Assignee: NITTO DENKO CORPORATION, Ibaraki-shi, Osaka (JP)

(21) Appl. No.: 12/282,550

(22) PCT Filed: Mar. 9, 2007
(86) PCT No.: PCT/JP2007/054637

§ 371 Date: Sep. 11, 2008

(30) Foreign Application Priority Data
Mar. 13, 2006 (JP) 2006-066910

(51) Int. Cl. B01D 63/10; B01D 63/06; B32B 37/14

(52) U.S. Cl. 210/457; 156/90

(57) ABSTRACT

An object of the present invention is to provide a spiral membrane element that can improve the barrier property of a fiber reinforced plastic layer having a fiber roll as a reinforcing phase and that can effectively prevent occurrence of cracks. The spiral membrane element of the present invention is a spiral membrane element containing a cylindrical roll R in which a separation membrane, a feed-side flow passageway member, and a permeate-side flow passageway member are spirally wound in a laminate state around a perforated center tube 5 and in which a sealing part for preventing mixing of feed-side fluid and permeate-side fluid is disposed, wherein a fiber reinforced plastic layer 26 having a fiber roll as a reinforcing phase is formed on the outer circumferential side of said cylindrical roll R, and a plastic layer 24 is disposed in the inner part or on the inner side of the fiber reinforced plastic layer 26 approximately over the entire length and approximately over the entire circumference of the fiber reinforced plastic layer 26.

### TECHNICAL FIELD

The present invention relates to a spiral membrane element in which a separation membrane, a feed-side flow passageway member, and a permeate-side flow passageway member are spirally wound in a laminated state around a perforated center tube and which can separate specific components that are present in various fluids (liquid or gas).

### BACKGROUND ART

Conventionally, as a fluid separation element used for reverse osmosis filtration, micro filtration, or the like, a spiral membrane element is known which is provided with a cylindrical roll R in which a separation membrane 1, a feed-side flow passageway member 2, and a permeate-side flow passageway member 3 are spirally wound in a laminate state around a perforated center tube 5 and in which sealing parts 11 to 13 for preventing mixing of feed-side fluid and permeate-side fluid are disposed, for example, as shown in FIG. 5.

In this spiral membrane element, the feed-side fluid (feed water) is led to the separation membrane 1 surface by the feed-side flow passageway member 2 and, after being separated by permeating through the separation membrane 1, the permeate-side fluid (permeated water) is led along the permeate-side flow passageway member 3 to the center tube 5 (water collection tube). Then, in such a spiral membrane element, there are cases in which a fiber reinforced plastic (FRP) is disposed on the outer circumference as an external material for the purpose of imparting a pressure resistance property and a shape retaining property at the time of pressurization operation (illustration is not given).

As shown in FIGS. 6(a) to (b), such a spiral membrane element is produced generally by fabricating a separation membrane unit U by stacking a material in which a feed-side flow passageway member 2 is disposed between the two sheets of a two-folded separation membrane 1 onto a permeate-side flow passageway member 3, and applying adhesives 4 and 6 for forming a sealing part that prevents mixing of feed-side fluid and permeate-side fluid to the permeate-side flow passageway member 3 located on the separation membrane peripheral parts (three sides), and spirally winding a single or a plurality of this unit U around a center tube 5, followed by sealing the separation membrane peripheral parts. This example is a case in which a plurality of membrane leaves (sealed envelope-shaped membrane) is present; however, there are cases in which a single membrane leaf is present.

Also, for forming the external material, there is known a process in which, generally after the membrane leaf is wound on the center tube, a glass roving (an assembled body made of strands of glass filaments) impregnated with a resin is wound around the outer circumferential surface of the cylindrical roll, and this is hardened and formed as an FRP (for example, see the patent documents 1 to 2). In addition, in the case of a membrane element, unlike the general structural members, the end part cannot be largely cut and removed, so that the winding angle of the glass roving cannot be increased, and the winding angle is at most about 5°.

Further, as a method for disposing a display label that displays a company name or a product number on the spiral membrane element, there is known a method in which a display label is stuck on the cylindrical roll before winding a glass roving and the hardening is carried out after winding the glass roving on this.

However, with the above method, when an increase in the scale of the display label is attempted, the effect of the unevenness of the adhesion surface of the cylindrical roll or the change in the outer diameter (the outer diameter near the end part of the membrane element increases) increases. For this reason, the adhesion of the display label decreases, thereby raising a problem in which the display label made to have a larger scale becomes wrinkled or distorted by peeling off, distortion, or the like at the time of winding the glass roving. Therefore, up to the present, no spiral membrane element is known that is provided with a display label or sheet having a larger scale.

On the other hand, in the case that a fiber reinforced plastic having a fiber roll as a reinforcing phase is formed as an outer cladding material like the case of using a glass roving, it will have a sufficient strength against the deformation due to the inner pressure of the membrane element but it will have a phase of being fragile against other forces, so that there are cases in which cracks occur along the fiber direction depending on the environment of use. Also, in the case of a fiber reinforced plastic having a fiber roll as a reinforcing phase, the air layer that has penetrated between the fibers forms a communication path, whereby the barrier property of the outer cladding material tends to decrease, raising a problem of corrosion deterioration caused by penetration of chemical agents.

### Patent Document 1: Japanese Patent Application Laid-Open (JP-A) No. 2001-17840

### Patent Document 2: JP-A No. 2000-354742

### DISCLOSURE OF THE INVENTION

### Problems to be Solved by the Invention

Therefore, an object of the present invention is to provide a spiral membrane element that can improve the barrier property of a fiber reinforced plastic layer having a fiber roll as a reinforcing phase and that can effectively prevent occurrence of cracks.

### Means for Solving the Problems

The aforementioned object can be achieved by the undermentioned present invention. The spiral membrane element of the present invention is a spiral membrane element containing a cylindrical roll in which a separation membrane, a feed-side flow passageway member, and a permeate-side flow passageway member are spirally wound in a laminate state around a perforated center tube and in which a sealing part for preventing mixing of feed-side fluid and permeate-side fluid is disposed, wherein a fiber reinforced plastic layer having a fiber roll as a reinforcing phase is formed on the outer circumferential side of said cylindrical roll, and a plastic layer is disposed in the inner part or on the inner side of the fiber reinforced plastic layer approximately over the entire length and approximately over the entire circumference of the fiber reinforced plastic layer.

According to the spiral membrane element of the present invention, a plastic layer is disposed approximately over the entire length and approximately over the entire circumference of the fiber reinforced plastic layer having a fiber roll as a reinforcing phase, so that the barrier property can be improved, and the occurrence of cracks can be effectively prevented. Also, since the plastic layer is not exposed to the surface, damages such as scars are less liable to occur, whereby the reinforcing effect can be maintained for a long period of time.

In the above description, the plastic layer is preferably a tubular heat-shrinking film. By using a tubular heat-shrinking film, the film can be made to follow well and to closely adhere to even a cylindrical roll whose outer surface has unevenness and whose outer diameter is not constant, whereby wrinkles or distortion is less liable to occur in the plastic layer even at the time of winding a reinforcing fiber on the upper layer.

Also, it is preferable that a fiber cloth reinforcement resin layer having a fiber cloth as a reinforcing phase is interposed between the fiber reinforced plastic layer and the plastic layer. By disposing the fiber cloth reinforcement resin layer, the reinforcing effect is produced in a plurality of directions, whereby the occurrence of cracks can be more effectively prevented. Also, as shown by the result of the Examples, when compared with the case of having the same thickness, the one containing the fiber cloth reinforcement resin layer has a higher transparency of the whole outer cladding material, whereby the visibility and the recognizability in the case of disposing a display or the like on the plastic layer are improved. The details of the reasons thereof are not clear; however, it seems that, while the interference of the scattered light is liable to occur because the filaments of the fiber are arranged uniformly in parallel in the fiber roll, a fiber cloth having a variation in the arrangement or in the density of the filaments will restrain the scattered light.

Further, the fiber cloth constituting the fiber cloth reinforcement resin layer is preferably a fiber cloth having a porosity of 10% or more. This facilitates penetration of the resin to the back side of the fiber cloth to improve the adhesion between the plastic layer and the fiber cloth reinforcement resin layer, whereby the visibility and the recognizability in the case of disposing a display or the like on the plastic layer are improved to a greater extent.

Also, the outer circumferential surface of the plastic layer is preferably subjected to a surface treatment that improves the adhesion to the resin constituting the fiber cloth reinforcement resin layer. This improves the adhesion between the fiber cloth reinforcement resin layer and the plastic layer, whereby the visibility and the recognizability in the case of disposing a display or the like on the plastic layer are improved to a greater extent.

### BRIEF DESCRIPTION OF THE DRAWINGS

FIG. 1 is a cross-sectional view showing one example of a spiral membrane element of the present invention.

FIG. 2 is a cross-sectional view showing another example of a spiral membrane element of the present invention.

FIG. 3 is a perspective view showing another example of a spiral membrane element of the present invention.

FIG. 4 is a cross-sectional view of an essential part showing another example of a spiral membrane element of the present invention.

FIG. 5 is a partially fractured perspective view showing one example of a spiral membrane element of the prior art (present invention).

FIG. 6 is a step view showing one example of a method of producing a spiral membrane element of the prior art (present invention).

FIG. 7 is a graph showing a result of evaluation of the adhesion between the epoxy resin and the design label.

### DESCRIPTION OF THE SYMBOLS

1 separation membrane
2 feed-side flow passageway member
3 permeate-side flow passageway member
4 adhesive
5 center tube
6 adhesive
24 plastic layer
25 fiber cloth reinforcement resin layer
26 fiber reinforced plastic layer
27 display label
R cylindrical roll
U separation membrane unit

### BEST MODES FOR CARRYING OUT THE INVENTION

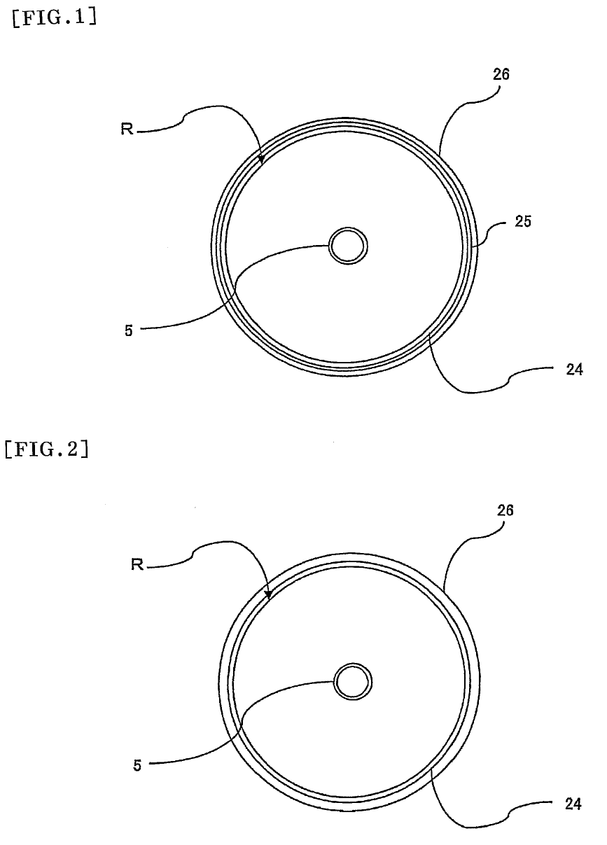

Hereafter, embodiments of the present invention will be described with reference to the drawings. FIG. 1 is a cross-sectional view showing one example of a spiral membrane element of the present invention.

In the spiral membrane element of the present invention, only the forming process and the structure of the external material are different from those of the conventional one, so that, for the other structures, all of the above-described construction of the conventional spiral membrane element can be applied.

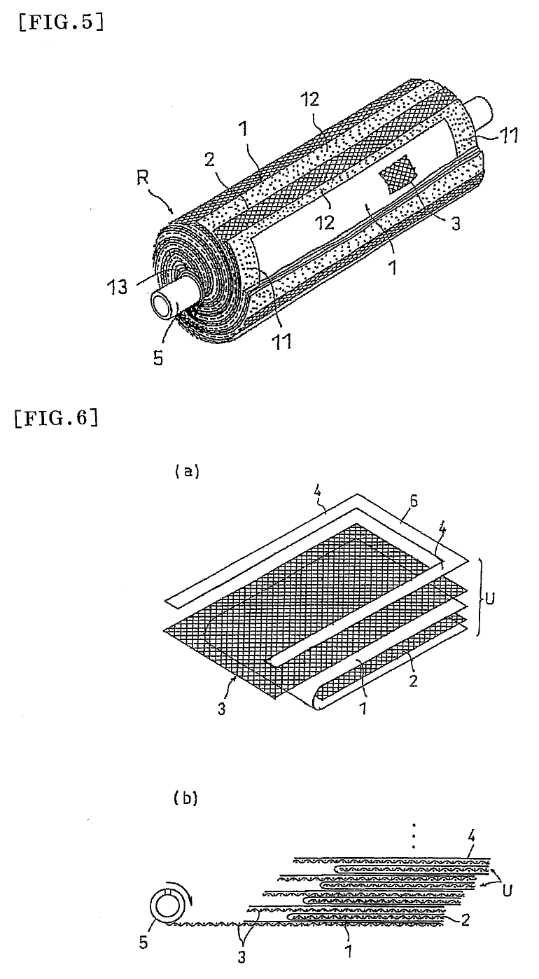

Therefore, the spiral membrane element of the present invention is provided with a cylindrical roll R in which a separation membrane 1, a feed-side flow passageway member 2, and a permeate-side flow passageway member 3 are spirally wound in a laminate state around a perforated center tube 5 and a sealing part for preventing mixing of feed-side fluid and permeate-side fluid is disposed, as shown in FIG. 5. The sealing part includes, for example, the two-end sealing part 11 and the outer circumferential side sealing part 12, and also a sealing part 13 can be formed in order to carry out sealing of the peripheries of the center tube 5.

The spiral membrane element of the present invention can be produced through a step of forming the cylindrical roll R by spirally winding the separation membrane 1, the feed-side flow passageway member 2, and the permeate-side flow passageway member 3 in a laminated state around the perforated center tube and a step of forming the sealing parts 11, 12 for preventing mixing of feed-side fluid and permeate-side fluid. Specifically, the production can be made, for example, by performing the steps shown in FIGS. 6(a) to 6(b).

As shown in FIG. 6(a), first, a unit is prepared by stacking a material in which a feed-side flow passageway member 2 is disposed between the two sheets of a two-folded separation membrane 1 onto a permeate-side flow passageway member 3, and applying adhesives 4 and 6 for forming a sealing part that prevents mixing of feed-side fluid and permeate-side fluid to the two end parts in the axial direction and the final end part of winding of the permeate-side flow passageway member 3. At this time, a protective tape may be bonded at the folding part of the separation membrane 1.

For the separation membrane 1, a reverse osmosis membrane, an ultrafiltration membrane, a micro filtration membrane, a gas separation membrane, a degassing membrane, and the like can be used. For the feed-side flow passageway member 2, a net-shaped material, a mesh-shaped material, a sheet having a groove, a wave-shaped sheet, or the like can be used. For the permeate-side flow passageway member 3, a fiber cloth such as non-woven cloth, woven cloth, or knitted cloth, a net-shaped material, a mesh-shaped material, a sheet having a groove, a wave-shaped sheet, or the like can be used.

The perforated center tube 5 may be one having an opening around a tube, so that any of the conventional ones can be used. Generally, the center tube 5 is formed with a material such as ABS resin, polyphenylene ether (PPE), or polysulfone (PSF), and the diameter thereof is, for example, 20 to 100 mm though it depends on the size of the membrane element.

As the adhesives 4 and 6, any of the conventionally known adhesives such as a urethane series adhesive, an epoxy series adhesive, and a hot melt adhesive can be used. However, in performing the hardening reaction by heating, an adhesive containing a thermosetting resin such as a urethane series adhesive or an epoxy series adhesive is preferable.

Next, as shown in FIG. 6(b), a plurality of these separation membrane units U are laminated and spirally wound around the perforated center tube 5, followed by hardening the adhesive or the like to form the sealing parts 11, 12, 13. At that time, an adhesive tape may be wound in a coil form to retain the shape of the cylindrical roll R.

The number of the separation membrane units U to be laminated is determined in accordance with the permeation flow rate that is needed, and may sufficiently be one or more layers; however, about 100 layers is an upper limit in consideration of the operability. Here, the longer the length of the separation membrane unit U is, the smaller the number of laminations will be.

As shown in FIG. 1, in the spiral membrane element of the present invention, a fiber reinforced plastic layer 26 having a fiber roll as a reinforcing phase is formed on the outer circumferential side of the cylindrical roll R, and a plastic layer 24 is disposed in the inner part or on the inner side of the fiber reinforced plastic layer 26 approximately over the entire length and approximately over the entire circumference of the fiber reinforced plastic layer 26. In the present embodiment, an example is shown in which the plastic layer 24 is a tubular heat-shrinking film, and a fiber cloth reinforcement resin layer 25 having a fiber cloth as a reinforcing phase is interposed between the fiber reinforced plastic layer 26 and the plastic layer 24.

Therefore, the spiral membrane element of the present embodiment can be produced by forming the fiber cloth reinforcement resin layer 25 and the fiber reinforced plastic layer 26 after forming the plastic layer 24 by allowing a tubular heat-shrinking film to adhere closely to the outer circumferential surface of the cylindrical roll R.

A heat-shrinking film is a film that generates shrinkage by being heated with use of an internal stress or the like based on a molecular orientation of the stretched film. Therefore, by covering the cylindrical roll R with a tubular heat-shrinking film and heating it by suitable heating means, the fiber cloth reinforcement resin layer 25 can be formed.

Examples of the heat-shrinking film include a cross-linked polyethylene shrinking film, a polystyrene-based shrinking film, a PET shrinking film, a vinyl chloride shrinking film, a PP shrinking film, an olefin-based multiple-layer shrinking film, and the like. For the tubular heat-shrinking film, either one of a seamed type and a seamless type can be used.

The heat-shrinking film may remain closely adhering to the outer circumferential surface of the cylindrical roll R without being bonded; however, the heat shrinking film may be bonded with use of an adhesive or a pressure-sensitive adhesive.

On the other hand, the fiber cloth reinforcement resin layer 25 can be formed, for example, by winding a fiber cloth which is impregnated with a resin or on which a resin is applied, followed by hardening. Application of the resin or the like can be carried out after winding the fiber cloth. The number of winding the fiber cloth is preferably one to five times.

For the fiber cloth constituting the reinforcing phase (support) of the fiber cloth reinforcement resin layer 25, in addition to fiber cloth made of a resin such as PET, PP, PE, PSF, or polyphenylene sulfide (PPS), glass fiber cloth such as glass cloth, metal fiber cloth such as metal mesh screen, or the like can be used. In the case of providing a display label in the inside, it is preferable to use fiber cloth made of glass fiber cloth such as glass cloth or transparent resin in view of enhancing the visibility and recognizability thereof.

The kind of the fiber cloth may be, for example, non-woven cloth, woven cloth, knitted cloth, or the like. From the viewpoint of the reinforcing effect and the visibility and recognizability, woven cloth such as plain weave fabric, twill weave fabric, satin weave fabric, mock leno weave fabric, or leno weave fabric is preferable. Also, the thickness of one sheet of the fiber cloth is preferably 0.03 to 0.6 mm, more preferably 0.1 to 0.4 mm.

For example, in the case of providing a display or the like on the plastic layer 24 such as the case of a design label, when the fiber cloth reinforcement resin layer 25 is disposed on the outer circumferential surface thereof, if the porosity of the fiber cloth is small, the resin does not reach the design label interface on the fiber cloth back side, and an air layer is generated to decrease the adhesion, thereby lowering the visibility and recognizability of the design label. In such a case, in order to satisfy the visibility and recognizability, the adhesion can be raised by providing a resin layer on the design label (under the fiber cloth). Also, by using a glass cloth or the like having a large porosity, the resin may penetrate down to the design label interface on the back side of the fiber cloth, thereby raising the adhesion. Also, when the porosity of the fiber cloth is large, the impregnation property of the resin is good, so that the resin constituting the fiber reinforced plastic layer 26 may be transferred to impregnate the fiber cloth with the resin even if the resin is not applied to the fiber cloth.

Therefore, the porosity of the fiber cloth such as glass cloth is preferably 10% or more. However, when the porosity is too large, the compression strength of the element decreases, so that the porosity is preferably from 20 to 40%. Here, the porosity of the fiber cloth represents a percentage of the area of the opening that is created between the fiber bundles when the fiber cloth is observed with a microscope in a stationary state. For example, the porosity can be determined by calculating the percentage of the area of the opening relative to the sum area of the repetition unit obtained by summing the areas of the fiber above the opening, the fiber to the right side of the opening, the overlapping part of these two fibers, and the opening.

For the resin to be applied on the fiber cloth, a polyurethane resin or an epoxy resin that is used at the time of forming the cylindrical roll R can be used as it is; however, the kind of the resin can be changed relative to the resin used in the cylindrical roll R. An epoxy resin, a polyester resin, and a polyurethane resin can be raised as examples of the resin that particularly improves the visibility and recognizability in combination with a glass fiber or the like.

Also, the fiber reinforced plastic layer 26 having a fiber roll as a reinforcing phase can be formed, for example, by winding a fiber, which is impregnated with a resin or on which a resin is applied, in a spiral form around the outer circumferential surface of the fiber cloth reinforcement resin layer 25, followed by hardening. The thickness of the fiber reinforced plastic layer 26 is, for example, 0.5 to 4 mm; however, it is preferably 0.5 to 2 mm in view of enhancing the visibility and recognizability.

As the fiber that forms the fiber roll, a multi-filament or a mono-filament that is twisted in accordance with the needs, or an assembled bundle body thereof can be used; however, various rovings for a fiber reinforced plastic can be preferably used. Also, as the kind of the fiber, for example, besides resin fibers such as PET, PP, PE, PSF, polyphenylene sulfide (PPS), or aramid, inorganic fibers such as glass and metal fibers such as steel wire can be used. However, when the display label is to be provided in the inside, it is preferable to use fibers made of glass fibers or transparent resin from the viewpoint of enhancing the visibility and recognizability thereof.

For the resin for application or the like to the fiber, a polyurethane resin or an epoxy resin that is used at the time of forming the cylindrical roll R can be used as it is; however, the kind of the resin can be changed relative to the resin used in the cylindrical roll R. An epoxy resin, a polyester resin, and a polyurethane resin can be raised as examples of the resin that particularly improves the visibility and recognizability in combination with a glass fiber. However, it is effective to harden the fiber cloth reinforcement resin layer 25 and the fiber reinforced plastic layer 26 at the same time. Also, from the view point of adhesiveness as well, it is preferable to use the same kind of resin as the resins of the two. Here, the condition at the time of hardening is suitably set in accordance with the resin to be used, the kind of the adhesive, and the like,

The sealing of the separation membrane unit U (cylindrical roll R) with resin and the hardening of the resin of the fiber reinforced plastic layer 26 or the like may be separately carried out; however, in the present invention, it is preferable to carry out the sealing of the separation membrane unit U (cylindrical roll R) with resin and the hardening of the resin of the fiber reinforced plastic layer 26 or the like simultaneously. In that case, it is preferable to use the same kind of resin for both of the resins. Namely, in performing the hardening reaction by heating, it is preferable to use a resin containing a thermosetting resin such as a urethane series adhesive or an epoxy series adhesive.

In the present invention, since a plastic layer 24 is disposed in the inner part or on the inner side of the fiber reinforced plastic layer 26, a sufficient strength is obtained even if the winding angle of the fiber roll is made small relative to the circumferential direction, so that a sufficient strength and durability can be obtained even if the winding angle is 1 to 10°.

In the spiral membrane element, trimming or the like of the two end parts of the cylindrical roll R may be carried out after the sealing with resin, so as to adjust the length in the axial direction. Further, a perforated end member, a sealing material, a reinforcing material, or the like may be disposed as necessary for the prevention of deformation (telescope or the like).

### OTHER EMBODIMENTS

(1) The above-described embodiment shows an example in which the display label is not provided on the plastic layer.

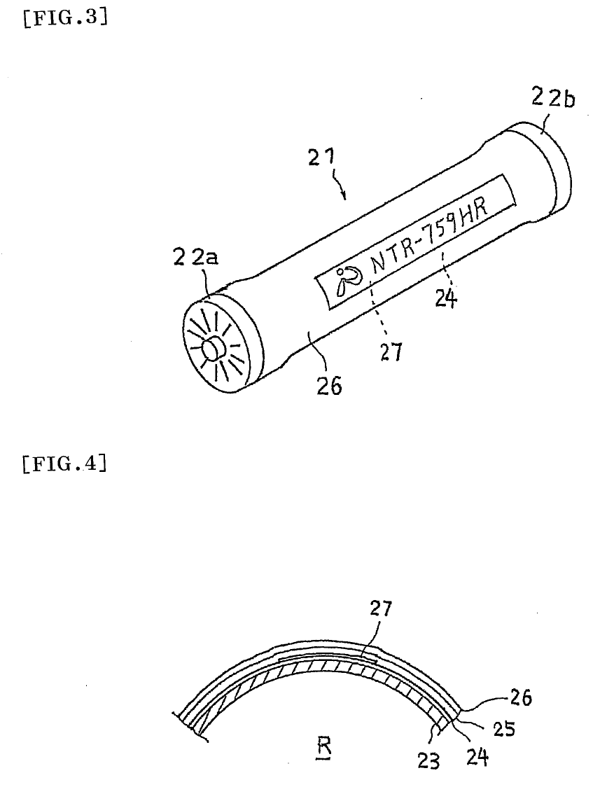

However, in the present invention, as shown in FIGS. 3 to 4, a display label 27 may be separately provided relative to the plastic layer 24, or the plastic layer 24 itself may be constructed as a display label.

Here, in the illustrated example, the plastic layer 24 is formed after an adhesive tape is wound in a coil form around the cylindrical roll R to form the shape-retaining layer 23. Also, end members 22a, 22b are disposed on the two ends of the body part 21 of the membrane element.

In the case of separately providing the display label 27, it is preferable to stick the display label 27 after the plastic layer 24 is formed. For example, in the case of forming the plastic layer 24 with use of a heat-shrinking film, a distortion or the like may possibly occur in the display if the display label is disposed on the plastic layer 24; however, when the display label 27 is stuck afterwards, the display label 27 can be provided in a beautiful manner without being affected by the distortion.

In the case of constituting the plastic layer 24 itself as a display label, direct printing can be made thereon. The printing is carried out on the outer surface and/or on the inner surface. Also, printing can be made in the intermediate layer with use of a multiple-layer type one as the plastic layer 24. Further, a plastic layer 24 containing a pigment or a dye can be used. By printing, the display can be made large so as to increase the field-of-view property and the expression power.

In the present invention, designs such as a pattern or a color tone can be subjected to deformation of some degree, so that it is preferably disposed on a heat-shrinking film or the like, and display or the like for which deformation is not preferable is most preferably stuck afterwards as a different display label 27. On the display label 27, for example, a product company name and a product number as well as a mounting direction and the like can be displayed.

When the display label 27 or the plastic layer 24 having that function is exfoliated from the resin (for example, an epoxy resin) constituting the fiber cloth reinforcement resin layer 25 or the fiber reinforced plastic layer 26 (those including the two are referred to as FRP), an air layer is generated to decrease the visibility and recognizability of the design label. As a measure for improvement thereof, one can mention a method of using a design label having a good adhesion to the resin such as an epoxy resin in addition to the method of enhancing the porosity of the fiber cloth such as described above.

The ink that is used in the design label is selected in consideration of the costs, the color hue, the facility of printing, and the like. However, by selecting those having a high adhesion to the epoxy resin or the like in relation to the characteristics or blending of the ink, the label and the FRP can be prevented from being exfoliated from each other and, as a result of this, decrease in the visibility and recognizability of the design label can be prevented. For example, as an ink having a high adhesion to the epoxy resin, one can use a chlorinated polypropylene (PP)-based ink, an urethane-based ink, or an acrylic (PA)-based ink that is not blended with wax can be used.

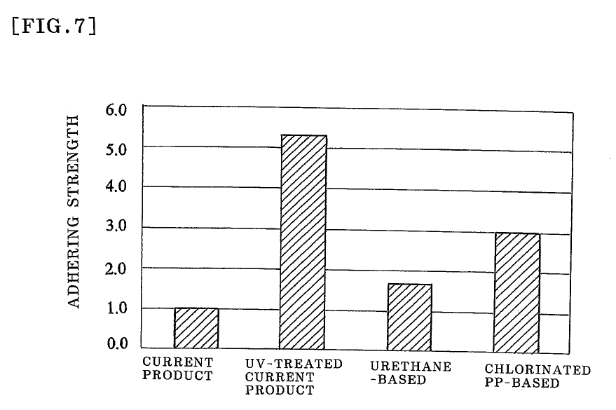

Also, in a similar manner, in order to prevent the design label and the FRP from being exfoliated from each other, it is effective means to perform a surface treatment on the display label 27 or the plastic layer 24 having that function. As the surface treatment, by performing a UV treatment, a corona treatment, or a plasma treatment on the surface, the adhesion to the epoxy resin can be improved. The result of evaluation of the adhesion between the epoxy resin and the design label is shown in FIG. 7.

Under the condition in which the ink of the design label has been changed or under the condition in which the UV treatment has been carried out, the adhesive strength is higher than that of the current products (polyamide-based ink, with no surface treatment), whereby the decrease in the visibility and recognizability generated from the exfoliation of the label and the FRP can be prevented. Here, for the adhering strength, the interfacial exfoliation strength between the FRP and the design label was measured with the precision all-purpose tester “Autograph AG5000B” manufactured by Shimadzu Corporation, and the evaluation was made relatively with the current product being 1.

(2) In the above-described embodiment, an example has been shown in which the plastic layer is a tubular heat-shrinking film. However, in the present invention, the plastic layer may be formed with a material other than a tubular heat-shrinking film, and a resin sheet or film can be preferably used. The thickness of the plastic layer is preferably 20 to 500 μm.

As the resin sheet or the like, those having a good adhesion to the cylindrical roll R and having a property of following are preferable, and examples thereof include sheets, films, and the like of PP, PE, polyvinyl chloride (PVC), polystyrene (PS), rubber, or the like. About one round of such a resin sheet is wound; however, a resin sheet having an adhesive layer is preferable.

In the present invention, by using a coloring, material that shields against the light for photosynthesis as the plastic layer, plants such as algae can be effectively prevented from being generated in the inside of the membrane element.

(3) In the above-described embodiment, an example has been shown in which a fiber cloth reinforcement resin layer is interposed between the fiber reinforced plastic layer and the plastic layer. However, in the present invention, it is sufficient that the plastic layer is disposed in the inner part or on the inner side of the fiber reinforced plastic layer approximately over the entire length and approximately over the entire circumference thereof. As shown in FIG. 2, the fiber reinforced plastic layer 26 having a fiber roll as a reinforcing phase may be disposed on the surface of the plastic layer 24.

Also, a fiber cloth reinforcement resin layer or a fiber reinforced plastic layer may be disposed in the inside of the plastic layer 24.

### EXAMPLES

Hereafter, Examples and the like that show the constitution and effects of the present invention in a specific manner will be described.

### Example 1

First, a membrane leaf unit made of an RO membrane ES20 manufactured by Nitto Denko Corporation. and a feed-side flow passageway member made of PP and having a thickness of 0.7 mm was prepared. Next, the tip end of the permeate-side flow passageway member made of PET and having a thickness of 0.3 mm was fixed to a hollow center tube made of PPE and having a diameter of 32 mm, and the membrane leaf unit was mounted on the permeate-side flow passageway member while applying a polyurethane resin at the part corresponding to the sealing part. Next, the mounted membrane leaf unit was wound while rotating the hollow center tube around the axis and applying a tension.

Next, an adhesive tape (having a width of 75 mm) was wound in a coil form without a gap to perform shape retaining, and it was covered with a tubular heat-shrinking film (made of a PP resin, having a thickness of 50 μm, a surface-treated product obtained by a corona treatment), and close adhesion was made by heating at 120° C. Further, a display label having a product name printed thereon was stuck onto the surface thereof.

Next, an epoxy resin was applied to a glass cloth having a thickness of 0.3 mm (manufactured by Nitto Bouseki Co., Ltd., plain weave fabric, having a porosity of 2%) so that the epoxy resin would spread to impregnate the entire surface, and about one round of this was wound, and the two ends were fixed with a two-sided tape.

Onto this, a glass roving impregnated with an epoxy resin (manufactured by Asahi Fiber Glass Co., Ltd.) was wound with a thickness of 1 mm, and the resin was hardened at 25° C. to form a fiber cloth reinforcement resin layer and a fiber reinforced plastic layer, thereby to fabricate a spiral membrane element.

The obtained spiral membrane element was such that the product name of the display label could be clearly recognized, and the upper layer part of the display label had an outlook near to a transparent resin. Also, the fiber reinforcement layer had a sufficient strength to withstand an actual operation.

### Example 2

A spiral membrane element was fabricated under the same condition as in the Example 1 except that a fiber reinforcement layer having a thickness of 2 mm was disposed without disposing a fiber cloth reinforcement layer having a glass cloth as a reinforcing phase. As a result thereof, as compared with a conventional product in which the heat-shrinking film is not disposed, cracks were less liable to occur; however, the visibility and recognizability decreased as compared with the Example 1.

### Example 3

After performing the steps up to the sticking of a display label in a similar manner as in the Example 1, about one round of a glass cloth having a thickness of 0.15 mm (manufactured by Nitto Bouseki Co., Ltd., plain weave fabric, having a porosity of 30%) was wound as it was, and the two ends were fixed with a two-sided tape. Onto this, a glass roving impregnated with an epoxy resin (manufactured by Asahi Fiber Glass Co., Ltd.) was wound with a thickness of 1.5 mm, and the resin was hardened at 25° C. to form a fiber cloth reinforcement resin layer and a fiber reinforced plastic layer, thereby to fabricate a spiral membrane element.

As a result of this, the visibility and recognizability were further improved by penetration of the epoxy resin to the display label surface through the opening of the glass cloth, and the strength was also at a level that does not raise a problem. Also, even if the epoxy resin was not applied to the glass cloth, the resin with which the glass roving was impregnated penetrated through the opening, whereby the glass cloth was sufficiently impregnated with this resin.

1. A spiral membrane element which is provided with a cylindrical roll in which a separation membrane, a feed-side flow passageway member, and a permeate-side flow passageway member are spirally wound in a laminate state around a perforated center tube and in which a sealing part for preventing mixing of feed-side fluid and permeate-side fluid is disposed,
wherein a fiber reinforced plastic layer having a fiber roll as a reinforcing phase is formed on the outer circumferential side of said cylindrical roll, and a plastic layer is disposed in the inner part or on the inner side of the fiber reinforced plastic layer approximately over the entire length and approximately over the entire circumference of the fiber reinforced plastic layer.

2. The spiral membrane element according to claim 1, wherein said plastic layer is a tubular heat-shrinking film.

3. The spiral membrane element according to claim 1, wherein a fiber cloth reinforcement resin layer having a fiber cloth as a reinforcing phase is interposed between said fiber reinforced plastic layer and said plastic layer.

4. The spiral membrane element according to claim 3, wherein the fiber cloth constituting said fiber cloth reinforcement resin layer is a fiber cloth having a porosity of 10% or more.

5. The spiral membrane element according to claim 1, wherein the outer circumferential surface of said plastic layer is subjected to a surface treatment that improves adhesion to the resin constituting said fiber cloth reinforcement resin layer.

6. The spiral membrane element according to claim 2, wherein a fiber cloth reinforcement resin layer having a fiber cloth as a reinforcing phase is interposed between said fiber reinforced plastic layer and said plastic layer.

7. The spiral membrane element according to claim 1, wherein a display label is interposed between said fiber reinforced plastic layer and said plastic layer or the plastic layer itself comprises a display label, and wherein the display label is visible from the exterior of the spiral membrane element.

8. The spiral membrane element according to claim 7, wherein the compositions of said fiber reinforced plastic layer and said plastic layer are selected to improve the visibility of the display label.

9. The spiral membrane element according to claim 7, wherein display label or the plastic layer comprising the display label is adhered to the layer externally adjacent thereto such that air is not generated at the external surface of the display label.

10. A process for producing a spiral membrane element comprising:
forming a cylindrical roll by spirally winding a separation membrane, a feed-side flow passageway member, and a permeate-side flow passageway member in a laminate state around a perforated center tube;
forming a sealing part for preventing mixing of feed-side fluid and permeate-side fluid;
forming a plastic layer over said cylindrical roll; and
forming a fiber reinforced plastic layer over said plastic layer and cylindrical roll.

11. The process of claim 10, further comprising hardening the fiber reinforced plastic layer.

12. A spiral membrane element comprising a cylindrical roll, wherein said cylindrical roll comprises:
a separation membrane;
a feed-side flow passageway member;
a permeate-side flow passageway member;
a sealing part that prevents mixing of feed-side fluid and permeate-side fluid; and
a perforated center tube,
wherein on the outer circumferential side of said cylindrical roll, a fiber reinforced plastic layer having a fiber roll as a reinforcing phase is formed, and
wherein a plastic layer is disposed in the inner part or on the inner side of the fiber reinforced plastic layer approximately over the entire length and approximately over the entire circumference of the fiber reinforced plastic layer.
